(19) United States
(12) Patent Application Publication
(10) Pub. No.: US 2016/0012272 A1
(43) Pub. Date: Jan. 14, 2016

(54) FINGERPRINT AUTHENTICATION SYSTEM AND A FINGERPRINT AUTHENTICATION METHOD BASED ON NFC

(71) Applicants: Kwok fong WONG, (US); Pui yi CHING, (US)

(72) Inventors: Kwok fong WONG, Heshan City Jiangmen (CN); Pui yi CHING, Heshan City Jiangmen (CN)

(21) Appl. No.: 14/647,710

(22) PCT Filed: Jan. 25, 2013
(86) PCT No.: PCT/CN13/70960

§ 371 Date: May 27, 2015

(30) Foreign Application Priority Data
Nov. 28, 2012 (CN) 201210491967.5

(51) Int. Cl. G06K 9/00; H04B 5/00; H04W 4/00

(52) U.S. Cl. CPC G06K 9/00006; H04W 4/008; H04B 5/0031; G06K 9/00087; G06K 9/00885; G06K 2009/00953

(57) ABSTRACT

The invention provides a fingerprint authentication system and a fingerprint authentication method based on NFC, and relates to the field of communication technology. The system comprises a fingerprint authentication platform, a Near-Field Communication (NFC) application terminal, and a NFC service terminal for providing an application service for the NFC application terminal. The fingerprint authentication platform is used for performing fingerprint authentication and registration on a valid user who utilizes the NFC application terminal, and generating a pair of keys according to the fingerprint information of the valid user. The NFC application terminal encrypts the personal information of the valid user according to a public key of the pair of keys, and transmits the encrypted personal information to the NFC service terminal in NFC way. The NFC service terminal decrypts the encrypted personal information according to a private key of the pair of keys to obtain the decrypted personal information, and provides an application service for the NFC application terminal according to the decrypted personal information. The system and method of the invention greatly improve the security of the personal information of a valid user, and maintains the interests of the valid user.

### FIELD OF THE INVENTION

The invention relates to the filed of communication technology, and more particularly to a fingerprint authentication system and a fingerprint authentication method based on NFC.

### DESCRIPTION OF THE RELATED ART

Near-Field Communication (referred to as NFC) belongs to the Near-Field Communication technology developed on Radio Frequency Identification (referred as RFID) and internet technology. Provided that any two devices are adjacent, NFC can achieve the functions such as dada exchange, content access, electric payment, electronic certificate or bill service exchange without any cable connection, thereby greatly facilitating the daily life of users.

It is found by the inventor, the limitation of NFC in prior art is obvious: firstly, the data information or transaction information of a user is easy to be leaked to an invalid user due to randomicity thereof, thereby leading to losses of the user; secondly, if a NFC application terminal of the prior art is lost or stolen, then anyone can use this NFC application terminal because it can not be determined that the holder of the NFC application terminal is a valid holder, this will cause immeasurable losses for the valid user.

### SUMMARY OF THE INVENTION

In order to solve the above problem of the prior art, a fingerprint authentication system and a fingerprint authentication method are provided in the embodiments of the invention.

The flowing technical solutions are provided in the invention.

In one aspect, the invention provides a fingerprint authentication system based on NFC, and the fingerprint authentication system based on NFC comprises a fingerprint authentication platform, a NFC application terminal and a NFC service terminal for providing an application service for the NFC application terminal.

The fingerprint authentication platform is used for performing fingerprint authentication and registration on a valid user who utilizes the NFC application terminal, and generating a pair of keys according to the fingerprint information of the valid user.

The NFC application terminal is used for encrypting the personal information of the valid user according to a public key of the pair of keys, and transmitting the encrypted personal information to the NFC service terminal in NFC way.

The NFC service terminal is used for decrypting the encrypted personal information according to a private key of the pair of keys to obtain the decrypted personal information, and providing an application service for the NFC application terminal according to the decrypted personal information.

In another aspect, the invention provides a fingerprint authentication method based on NFC, the method comprises the following steps:
performing fingerprint authentication and registration on a valid user who uses a NFC application terminal by means of a fingerprint authentication platform, and generating a pair of keys according to the fingerprint information of the valid user;
encrypting the personal information of the valid user by means of a NFC application terminal according to a public key of the pair of keys, and transmitting the encrypted personal information to a NFC service terminal in NFC way; and
decrypting the encrypted personal information by means of the NFC service terminal according to a private key of the pair of keys to obtain the decrypted personal information, and providing an application service for the NFC application terminal according to the decrypted personal information.

The invention has the following advantages by utilizing the technical solutions of the embodiments.

Fingerprint authentication and registration is performed on the valid user who uses a NFC application terminal by a fingerprint authentication platform, thus, the personal information of the valid user is transmitted between the NFC application terminal and the NFC service terminal after encryption, this achieves the authentication of the valid user and the management of the personal information of the valid user, thereby greatly improving the security of the personal information of the valid user and maintaining the interests of the valid user.

### BRIEF DESCRIPTION OF THE DRAWINGS

In order to illustrate more clearly the technical solutions of the embodiments of the invention, the drawings used in the embodiments will be described simply hereinafter. Obviously, the drawings are given by way of example, and for a person skilled in the art, other equivalent drawings can be obtained according to these drawings without any creative work.

FIG. 1 is a schematic drawing of a fingerprint authentication system based on NFC according to embodiment 1 of the invention;

FIG. 2 is a schematic drawing of a fingerprint authentication system based on NFC according to embodiment 2 of the invention;

FIG. 3 is a flow chart of a fingerprint authentication method according to embodiment 3 of the invention;

FIG. 4 is a flow chart of a fingerprint authentication method according to embodiment 4 of the invention.

### DETAILED DESCRIPTION OF THE INVENTION

In order to make the object, technical solutions and advantages of the invention more clearly, the embodiments will be described hereinafter in more detail in connection with drawings.

### Embodiment 1

FIG. 1 is a schematic drawing of a fingerprint authentication system based on NFC according to embodiment 1. As shown in FIG. 1, the fingerprint authentication system 100 based on NFC of embodiment 1 specifically comprises a fingerprint authentication platform 11, a NFC application terminal 12, and a NFC service terminal 13 for providing an application service for the NFC application terminal 12.

The fingerprint authentication platform 11 performs fingerprint authentication and registration on a valid user who utilizes the NFC application terminal 12, and generates a pair of keys according to the fingerprint information of the valid user. The NFC application terminal 12 encrypts the personal information of the valid user according to a public key of the pair of keys, and transmits the encrypted personal information to the NFC service terminal 13 in NFC way. The NFC service terminal 13 decrypts the encrypted personal information according to a private key of the pair of keys to obtain decrypted personal information, and provides an application service for the NFC application terminal 12 according to the decrypted personal information.

In the fingerprint authentication system based on NFC of embodiment 1 of the invention, the fingerprint authentication and registration is performed on the valid user who uses a NFC application terminal 12 by a fingerprint authentication platform 11, thus, the personal information of the valid user is transmitted between the NFC application terminal 12 and the NFC service terminal 13 after encryption, this achieves the authentication of the valid user and the management of the personal information of the valid user, thereby greatly improving the security of the personal information of the valid user and maintaining the interests of the valid user.

### Embodiment 2

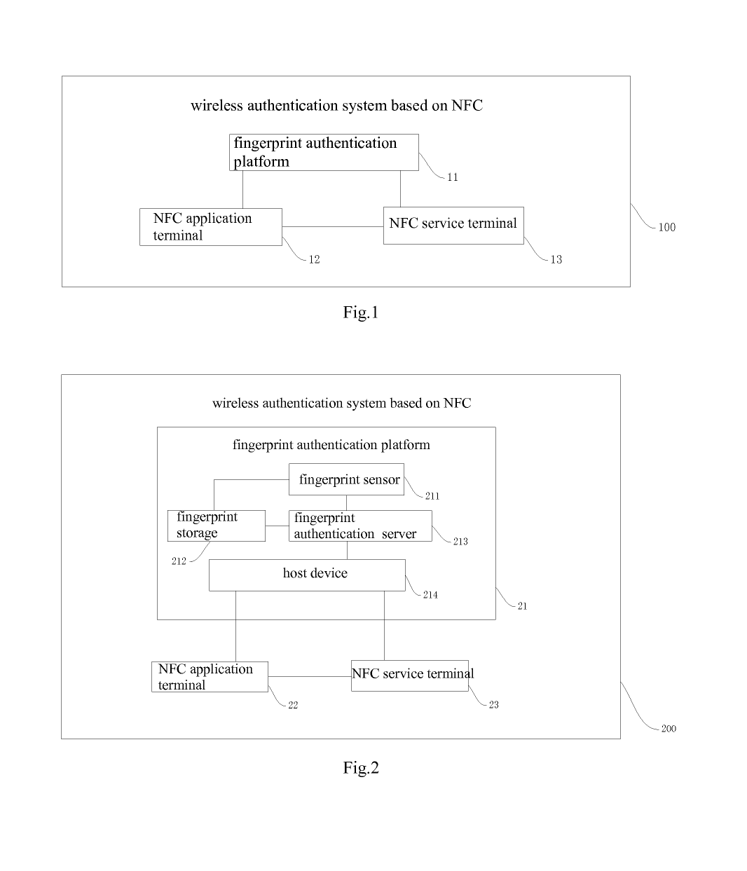

FIG. 2 is a schematic drawing of a fingerprint authentication system based on NFC according to embodiment 2. As shown in FIG. 2, the fingerprint authentication system 200 based on NFC of embodiment 2 specifically comprises a fingerprint authentication platform 21, a NFC application terminal 22, and a NFC service terminal 23 for providing an application service for the NFC application terminal 22.

The fingerprint authentication platform 21 performs fingerprint authentication and registration on a valid user who utilizes the NFC application terminal 22, and generates a pair of keys according to the fingerprint information of the valid user. The NFC application terminal 22 encrypts the personal information of the valid user according to a public key of the pair of keys, and transmits the encrypted personal information to the NFC service terminal 23 in NFC way. The NFC service terminal 23 decrypts the encrypted personal information according to a private key of the pair of keys to obtain decrypted personal information, and provides an application service for the NFC application terminal 22 according to the decrypted personal information.

Preferably, the fingerprint authentication platform 21 comprises a fingerprint sensor 211, a fingerprint storage 212 and a fingerprint authentication server 213. The fingerprint sensor extracts the fingerprint information of a user. The fingerprint storage 212 registers and stores the fingerprint information of the valid user extracted by the fingerprint sensor. The fingerprint authentication server 213 authenticates the fingerprint information extracted by the fingerprint sensor and the fingerprint information of the valid user registered and stored in the fingerprint storage, to confirm the fingerprint information extracted by the finger sensor being the fingerprint information of the valid user.

Preferably, the fingerprint authentication server 213 comprises an alarm module (not shown in FIG. 2). If the fingerprint information extracted by the fingerprint sensor is the fingerprint information of an invalid user, then the alarm module sends alarm information. By means of the alarm information, the user of the NFC service terminal 23 learns that the user holding the NFC application terminal is an invalid user, and thus will not provide any application service for the user, thereby improving the security of the valid user.

Preferably, the fingerprint authentication platform 21 also may comprise a host device 214. The host device 214 generates a pair of keys according to the fingerprint information of the valid user, transmits the public key of the pair of keys to the NFC application terminal in NFC way, and transmits the private key of the pair of keys to the NFC service terminal.

In the fingerprint authentication system based on NFC of embodiment 2 of the invention, the fingerprint authentication and registration is performed on the valid user who uses a NFC application terminal 22 by a fingerprint authentication platform 21, thus, the personal information of the valid user is transmitted between the NFC application terminal 22 and NFC service terminal 23 after encryption, this achieves the authentication of the valid user and the management of the personal information of the valid user, thereby greatly improving the security of the personal information of the valid user and maintaining the interests of the valid user.

It is should be noted that, the NFC application terminal and the application service performed by the NFC application terminal disclosed in the above embodiments 1 and 2 comprise at least one of electronic payment, electronic certificate, electronic bill business and data exchange. The NFC application terminal may specifically be a mobile terminal (for example, a mobile phone, and a tablet computer). The NFC service terminal may specifically be contactless smart card, or reader-writer terminal of a smart card. A person skilled in the art should appreciate that, the above description is given only for illustration, and it will not be considered as limitation to the NFC application terminal and NFC service terminal of the embodiments of the invention.

The scenes applicable to the embodiments of the invention will be described hereinafter with reference to FIG. 2 by way of example. Firstly, the fingerprint information of the valid user is registered utilizing the fingerprint sensor 211 of the fingerprint authentication platform 21, and the fingerprint information of the valid user is stored in the fingerprint storage 212, meanwhile, the host device 214 in the fingerprint authentication platform 21 generates a pair of keys (such as, obtaining a pair of keys comprising a private key and a public key by means of a public-key encryption algorithm), the host device 214 transmits the public key of the pair of keys to the NFC application terminal 22 in NFC way, and the NFC application terminal 22 encrypts the personal information of the valid user according to the public key, this means that the valid user holding the NFC application terminal 22 is enabled to use the application provided by the NFC service terminal 23.

When the user holding the NFC application terminal enjoys the NFC application (such as, electronic payment, electronic bill business or data exchange business) provided by the NFC service terminal, the fingerprint sensor 211 extracts the fingerprint information of the user holding the NFC application terminal, the fingerprint authentication server 213 compares the fingerprint information of the user with the fingerprint information of the valid user stored in the fingerprint storage 212, and thus confirms whether the holder is a valid user or not. If the holder is a valid user, then the NFC application terminal 22 transmits the encrypted personal information to the NFC service terminal 23 by NFC transmission, and the host device 214 transmits the private key of the pair of keys to the NFC service terminal 23 by NFC transmission, and the NFC service terminal 23 decrypts the encrypted personal information according to the private key and provides an application service for the NFC application terminal 22 according to the decrypted personal information.

It should be noted that, the personal information of the above embodiments 1 and 2 may specifically comprise the account number and personal identity information corresponding to the application performed by the user.

### Embodiment 3

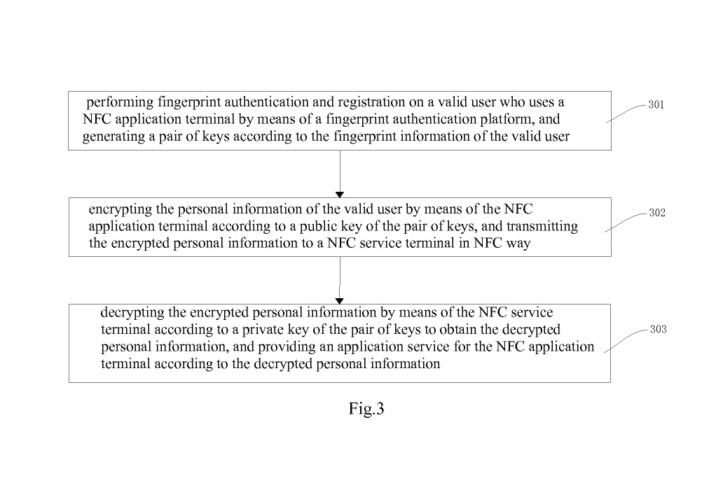

FIG. 3 is a flow chart of a fingerprint authentication method according to embodiment 3 of the invention, and the embodiment 3 can be achieved by means of the fingerprint authentication systems shown in embodiments of FIGS. 1-2. As shown in FIG. 3, the embodiment 3 of the invention comprises the following steps:
step 301: performing fingerprint authentication and registration on a valid user who uses a NFC application terminal by means of a fingerprint authentication platform, and generating a pair of keys according to the fingerprint information of the valid user;
step 302: encrypting the personal information of the valid user by means of the NFC application terminal according to a public key of the pair of keys, and transmitting the encrypted personal information to a NFC service terminal in NFC way; and
step 303: decrypting the encrypted personal information by means of the NFC service terminal according to a private key of the pair of keys to obtain the decrypted personal information, and providing an application service for the NFC application terminal according to the decrypted personal information.

In the fingerprint authentication method based on NFC of embodiment 3 of the invention, the fingerprint authentication and registration is performed on the valid user who uses a NFC application terminal by a fingerprint authentication platform, and a pair of keys are generated according to the fingerprint information of the valid user, thus, the personal information of the valid user is transmitted between the NFC application terminal and NFC service terminal after encryption, this achieves the authentication of the valid user and the management of the personal information of the valid user, thereby greatly improving the security of the personal information of the valid user and maintaining the interests of the valid user.

### Embodiment 4

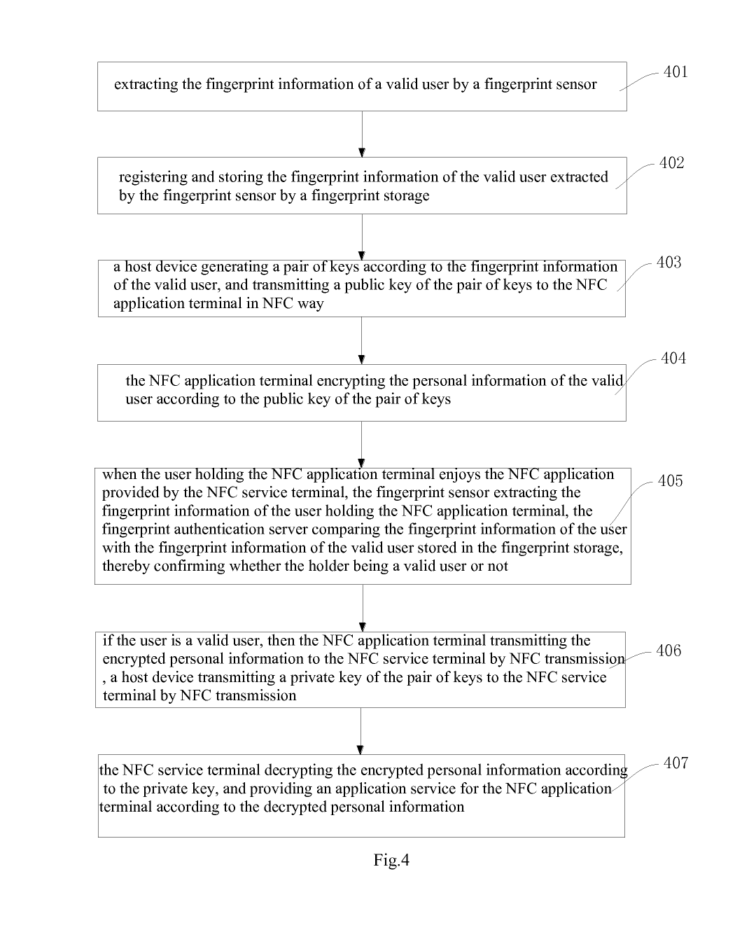

FIG. 4 is a flow chart of a fingerprint authentication method according to embodiment 4 of the invention, and the embodiment 4 can be achieved by means of the fingerprint authentication systems based on NFC shown in embodiments of FIGS. 1-2. As shown in FIG. 4, the embodiment 4 of the invention comprises the following steps:
step 401: extracting the fingerprint information of a valid user by a fingerprint sensor.
step 402: registering and storing the fingerprint information of the valid user extracted by the fingerprint sensor by a fingerprint storage.
step 403: a host device generating a pair of keys according to the fingerprint information of the valid user by, and transmitting a public key of the pair of keys to the NFC application terminal in NFC way.

By means of the above steps 401-403, the authentication and registration of the valid user of the NFC application terminal can be achieved by means of the fingerprint authentication platform, and this process refers to the step of a valid user being enabled to use the application provided by the NFC service terminal, and is the premise of enjoying the application provided by the NFC service terminal.
step 404: the NFC application terminal encrypting the personal information of the valid user according to the public key of the pair of keys.

By means of the step 404, the NFC application terminal encrypts the personal information of the valid user, this can prevent an invalid user from abusing the application provided by the NFC service terminal and opened by the NFC application terminal.
step 405: when the user holding the NFC application terminal enjoys the NFC application provided by the NFC service terminal, the fingerprint sensor extracting the fingerprint information of the user holding the NFC application terminal, the fingerprint authentication server comparing the fingerprint information of the user with the fingerprint information of the valid user stored in the fingerprint storage, thereby confirming whether the holder being a valid user or not.

By means of the step 405, the fingerprint authentication is performed on the holder of the NFC application terminal, and this will further prevent the invalid user who does not perform fingerprint registration from abusing the application provided by the NFC service terminal and opened by the NFC application terminal. Furthermore, if the fingerprint information extracted by the fingerprint sensor is the fingerprint information of an invalid user, then alarm information can be sent out by the fingerprint authentication server.
step 406: if the user is a valid user, then the NFC application terminal transmitting the encrypted personal information to the NFC service terminal by NFC transmission, a host device transmitting the private key of the pair of keys to the NFC service terminal by NFC transmission; and
step 407: the NFC service terminal decrypting the encrypted personal information according to the private key, and providing an application service for the NFC application terminal according to the decrypted personal information.

In the fingerprint authentication method based on NFC of embodiment 4 of the invention, the fingerprint authentication and registration is performed on the valid user who uses a NFC application terminal by a fingerprint authentication platform, and a pair of keys are generated according to the fingerprint information of the valid user, thus, the personal information of the valid user is transmitted between the NFC application terminal and the NFC service terminal after encryption, this achieves the authentication of the valid user and the management of the personal information of the valid user, thereby greatly improving the security of the personal information of the valid user and maintaining the interests of the valid user.

It is should be noted that, the NFC application terminal and the application service performed by the NFC application terminal disclosed in the above embodiments 3 and 4 comprise at least one of electronic payment, electronic certificate, electronic bill business and data exchange business. The NFC application terminal may specifically be a mobile terminal (for example, a mobile phone and tablet computer). The NFC service terminal may specifically be contactless smart card, or reader-writer terminal of a smart card. A person skilled in the art should appreciate that, the above description is given only for illustration, and it will not be considered as limitation to the NFC application terminal and NFC service terminal of the embodiments of the invention. Furthermore, it should be noted that, the personal information of the above embodiments 3 and 4 may specifically comprise the account number and personal identity information corresponding to the application performed by the user.

In conclusion, before a valid user performs an application such as electronic payment, electronic certificate, electronic bill business and data exchange utilizing NFC, a pair of keys are generated by means of a fingerprint authentication platform, thus, the NFC application terminal encrypts the personal information of the valid user, and transmits the encrypted personal information to the NFC service terminal in NFC way, and the NFC service terminal can perform various applications such as electronic payment, electric bill business and data change, only by decrypting the fingerprint information of the valid user using the corresponding private key, this will greatly improve the information security of the valid user and maintain the interests of the valid user.

It should be noted that: in the above embodiments, the partition of the above functional modules are illustrated by way of example, in practical applications, the above functions can be achieved by different functional modules as required, that is to say, the inner structure of the system is divided into different functional modules, to reach the whole or part of the functions as described above. Furthermore, the fingerprint authentication systems provided by the above embodiments and the fingerprint authentication methods belong to the same technical conception, and the specific implementation process of these systems can be detailedly seen in method embodiments, and thus will not be described here in more detail.

The numberings of the embodiments are given only for description, instead of representing the quality of the embodiments.

A person skilled in the art shall appreciate that, part or all of the steps achieving the above embodiments can be completed by means of hardware, or by instructing related hardware via a program, and the program may be stored in a computer-readable storage medium which may be a read only memory, magnetic disk or optical disc or the like.

The preferred embodiments as above described are not intended for limiting of the invention, any variations, equivalent substitutions, improvement within the spirit and scope of the invention are contained in the extent of protection of the invention.

1. A fingerprint authentication system based on Near-Field Communication (NFC), comprising a fingerprint authentication platform, a NFC application terminal, and a NFC service terminal for providing an application service for the NFC application terminal, wherein:
the fingerprint authentication platform is used for performing fingerprint authentication and registration on a valid user who utilizes the NFC application terminal, and generating a pair of keys according to the fingerprint information of the valid user;
the NFC application terminal being used for encrypting the personal information of the valid user according to a public key of the pair of keys, and transmitting the encrypted personal information to the NFC service terminal in NFC way; and
the NFC service terminal being used for decrypting the encrypted personal information according to a private key of the pair of keys to obtain the decrypted personal information, and providing an application service for the NFC application terminal according to the decrypted personal information.

2. The fingerprint authentication system based on Near-Field Communication (NFC) as claimed in claim 1, wherein the fingerprint authentication platform comprises:
a fingerprint sensor for extracting the fingerprint information of a user;
a fingerprint storage for registering and storing the fingerprint information of the valid user extracted by the fingerprint sensor; and
a fingerprint authentication server for authenticating the fingerprint information extracted by the fingerprint sensor and the fingerprint information of the valid user registered and stored in the fingerprint storage, to confirm the fingerprint information extracted by the finger sensor being the fingerprint information of the valid user.

3. The fingerprint authentication system based on Near-Field Communication (NFC) as claimed in claim 2, wherein the fingerprint authentication server comprises an alarm module for sending alarm information if the fingerprint information extracted by the fingerprint sensor is the fingerprint information of an invalid user.

4. The fingerprint authentication system based on Near-Field Communication (NFC) as claimed in claim 1, wherein the fingerprint authentication platform comprises a host device for generating a pair of keys according to the fingerprint information of the valid user, transmitting the public key of the pair of keys to the NFC application terminal in NFC way, and transmitting the private key of the pair of keys to the NFC service terminal in NFC way.

5. The fingerprint authentication system based on Near-Field Communication (NFC) as claimed in any of claim 1, wherein the NFC application terminal and the application service performed by the NFC application terminal comprises at least one of electronic payment, electronic certificate, electronic bill business and data exchange business.

6. A fingerprint authentication method based on Near-Field Communication (NFC), comprising the steps of:
performing fingerprint authentication and registration on a valid user who uses a NFC application terminal by means of a fingerprint authentication platform, and generating a pair of keys according to the fingerprint information of the valid user;
encrypting the personal information of the valid user by means of a NFC application terminal according to a public key of the pair of keys, and transmitting the encrypted personal information to a NFC service terminal in NFC way; and
decrypting the encrypted personal information by means of the NFC service terminal according to a private key of the pair of keys to obtain the decrypted personal information, and providing an application service for the NFC application terminal according to the decrypted personal information.

7. The fingerprint authentication method based on Near-Field Communication (NFC) as claimed in claim 6, wherein the step of performing fingerprint authentication and registration on a valid user who uses a NFC application terminal by means of a fingerprint authentication platform comprises:
extracting the fingerprint information of a valid user by a fingerprint sensor;
registering and storing the fingerprint information of the valid user extracted by the fingerprint sensor by means of a fingerprint storage; and
authenticating the fingerprint information extracted by the fingerprint sensor and the fingerprint information of the valid user registered and stored in the fingerprint storage, to confirm the fingerprint information extracted by the finger sensor being the fingerprint information of the valid user.

8. The fingerprint authentication method based on Near-Field Communication (NFC) as claimed in claim 7, wherein the method also comprises the steps of:
the NFC application terminal transmitting the encrypted personal information to the NFC service terminal by NFC transmission if the user is a valid user,; and
transmitting the private key of the pair of keys to the NFC service terminal in NFC transmission by a host device.

9. The fingerprint authentication method based on Near-Field Communication (NFC) as claimed in claim 6, wherein the step of performing fingerprint authentication and registration on a valid user of a NFC application terminal by means of a fingerprint authentication platform, and generating a pair of keys according to the fingerprint information of the valid user also comprises:
generating a pair of keys according to the fingerprint information of the valid user by a host device; and
transmitting the public key of the pair of keys to the NFC application terminal in NFC way.

10. The fingerprint authentication method based on Near-Field Communication (NFC) as claimed in any of claim 6, wherein the NFC application terminal and the application services performed by the NFC application terminal comprise at least one of electronic payment, electronic certificate, electronic bill business and data exchange business.

11. The fingerprint authentication system based on Near-Field Communication (NFC) as claimed in any of claims 2, wherein the NFC application terminal and the application service performed by the NFC application terminal comprises at least one of electronic payment, electronic certificate, electronic bill business and data exchange business.

12. The fingerprint authentication system based on Near-Field Communication (NFC) as claimed in any of claims 3, wherein the NFC application terminal and the application service performed by the NFC application terminal comprises at least one of electronic payment, electronic certificate, electronic bill business and data exchange business.

13. The fingerprint authentication system based on Near-Field Communication (NFC) as claimed in any of claims 4, wherein the NFC application terminal and the application service performed by the NFC application terminal comprises at least one of electronic payment, electronic certificate, electronic bill business and data exchange business.

14. The fingerprint authentication method based on Near-Field Communication (NFC) as claimed in any of claims 7, wherein the NFC application terminal and the application services performed by the NFC application terminal comprise at least one of electronic payment, electronic certificate, electronic bill business and data exchange business.

15. The fingerprint authentication method based on Near-Field Communication (NFC) as claimed in any of claims 8, wherein the NFC application terminal and the application services performed by the NFC application terminal comprise at least one of electronic payment, electronic certificate, electronic bill business and data exchange business.

16. The fingerprint authentication method based on Near-Field Communication (NFC) as claimed in any of claims 9, wherein the NFC application terminal and the application services performed by the NFC application terminal comprise at least one of electronic payment, electronic certificate, electronic bill business and data exchange business.
